(19) United States
(12) Patent Application Publication
(10) Pub. No.: US 2026/0189347 A1
(43) Pub. Date: Jul. 2, 2026

(54) METHOD, APPARATUS AND COMPUTER PROGRAM

(71) Applicant: NOKIA TECHNOLOGIES OY, Espoo (FI)

(72) Inventors: Esa Tapani TIIROLA, Oulu (FI); Kari Juhani HOOLI, Oulu (FI); Sami-Jukka HAKOLA, Kempele (FI); Jorma Johannes KAIKKONEN, Oulu (FI)

(21) Appl. No.: 19/116,473

(22) PCT Filed: Sep. 20, 2023
(86) PCT No.: PCT/EP2023/075941

§ 371 Date: Mar. 28, 2025

(30) Foreign Application Priority Data
Sep. 29, 2022 (GB) 2214243.4

(51) Int. Cl. H04L 5/00

(52) U.S. Cl. CPC H04L 5/0053

(57) ABSTRACT

There is provided an apparatus comprising means for detecting a primary synchronisation signal and a secondary synchronisation signal transmitted from a network node, and means for using the detected primary and secondary synchronisation signals to determine a number of resource blocks allocated for a physical broadcast channel. The apparatus also comprises means for determining a lowest resource block, in frequency, of the physical broadcast channel, and means for determining a lowest resource block, in frequency, for a control resource set 0, CORESET #0, to be the same as the determined lowest resource block of the physical broadcast channel.

### CROSS-REFERENCE TO RELATED APPLICATION

This application claims priority to, and the benefit of, GB application No. 2214243.4 filed on Sep. 29, 2022, which is incorporated herein by reference in its entirety.

### FIELD

The present application relates to a method, apparatus, and computer program for a wireless communication system.

### BACKGROUND

A communication system may be a facility that enables communication sessions between two or more entities such as user terminals, base stations/access points and/or other nodes by providing carriers between the various entities involved in the communications path. A communication system may be provided, for example, by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

### SUMMARY

According to an aspect, there is provided an apparatus comprising: means for detecting a primary synchronisation signal and a secondary synchronisation signal transmitted from a network node; means for using the detected primary and secondary synchronisation signals to determine a number of resource blocks allocated for a physical broadcast channel; means for determining a lowest resource block, in frequency, of the physical broadcast channel; and means for determining a lowest resource block, in frequency, for a control resource set 0, CORESET #0, to be the same as the determined lowest resource block of the physical broadcast channel.

In an example, the means for determining the lowest resource block, in frequency, on which the physical broadcast channel was transmitted comprises: means for determining the lowest resource block, in frequency, on which the physical broadcast channel was transmitted, from the network node, after a puncturing of the resource blocks.

In an example, the apparatus comprises: means for determining valid resource blocks for the CORESET #0 by aligning with valid resource blocks of the physical broadcast channel in order to determine a size of the CORESET #0; and means for determining a control channel element allocation for the CORESET #0 based on: i) the lowest resource block, and ii) the valid resource blocks, of the CORESET #0.

In an example, the apparatus comprises: means for using the determined CORESET #0 to communicate with the network node.

In an example, the apparatus comprises: means for, in response to detecting the primary and secondary synchronisation signals, demodulating and decoding the associated physical broadcast channel.

In an example, the physical broadcast channel is associated with the detected primary and secondary synchronisation signals.

In an example, the means for determining valid resource blocks for the CORESET #0 comprises: means for determining that the valid resource blocks for the CORESET #0 are the resource blocks with full control channel elements.

In an example, the means for determining valid resource blocks for the CORESET #0 comprises: means for determining that the valid resource blocks for the CORESET #0 are the resource blocks that cover fifteen resource blocks, with full and partial control channel elements.

In an example, the means for determining the size of the CORESET #0 comprises one of: means for determining a maximum number of full control channel elements that fit into fifteen resource blocks; means for determining a maximum number of full and partial control channel elements that fit into fifteen resource blocks; means for determining a number of full control channel elements using a predetermined number of control channel elements; means for determining a number of resource blocks using predefined multiple of six resource blocks, that is above a total of fifteen resource blocks.

In an example, the means for determining a control channel element allocation for the CORESET #0 comprises: means for determining the control channel element allocation for the CORESET #0 using non-interleaved control channel element mapping.

In an example, the apparatus comprises: means for, in response to determining the valid resource blocks for the CORESET #0, determining, using the physical broadcast channel, an index that provides information about control channel element allocation within the valid resource blocks of the CORESET #0.

In an example, the apparatus comprises: means for receiving, from the network node, a configuration associated with the physical downlink control channel; and means for, in response to the receiving, determining the CORESET #0 for all search spaces using the CORESET #0 in an initial bandwidth part.

In an example, the apparatus comprises means for receiving, from the network node, a configuration associated with the physical downlink control channel; and means for, after receiving the configuration, using parameters comprised within the configuration to determine a further CORESET #0 that is applied for all other search spaces using CORESET #0 except a Type0 PDCCH search space, wherein the further

CORESET #0 used by the other search spaces is wider, in frequency, than the CORESET #0 used by Type0-PDCCH, wherein the further CORESET #0 comprises the resource blocks used by the CORESET #0 applied for Type0 PDCCH search space.

In an example, the apparatus comprises: means for receiving, from the network node, a configuration associated with the physical downlink control channel; and means for, using one or more parameters comprised within the configuration associated with the physical downlink control channel to determine whether one of: a lower edge in frequency, or a higher edge in frequency, of the CORESET #0 is to be aligned with resource blocks of the physical broadcast channel.

In an example, the apparatus comprises: means for determining a channel bandwidth that the network node is operating with using the detected primary and secondary synchronisation signals.

In an example, the means for determining comprises means for determining a synchronisation raster point using the detected primary and secondary synchronisation signals so to determine the channel bandwidth that the network node is operating with.

In an example, the channel bandwidth is determined to be three megahertz.

In an example, there are fifteen resource blocks available for the physical broadcast channel.

In an example, one of: the apparatus is for a user equipment, the apparatus is located within the user equipment, or the apparatus is the user equipment.

According to an aspect, there is provided an apparatus comprising: at least one processor, and at least one memory storing instructions that, when executed by the one or more processors, cause the apparatus to perform: detecting a primary synchronisation signal and a secondary synchronisation signal transmitted from a network node; using the detected primary and secondary synchronisation signals to determine a number of resource blocks allocated for a physical broadcast channel; determining a lowest resource block, in frequency, of the physical broadcast channel; and determining a lowest resource block, in frequency, for a control resource set 0, CORESET #0, to be the same as the determined lowest resource block of the physical broadcast channel.

In an example, the determining the lowest resource block, in frequency, on which the physical broadcast channel was transmitted comprises: determining the lowest resource block, in frequency, on which the physical broadcast channel was transmitted, from the network node, after a puncturing of the resource blocks.

In an example, the apparatus is caused to perform: determining valid resource blocks for the CORESET #0 by aligning with valid resource blocks of the physical broadcast channel in order to determine a size of the CORESET #0; and determining a control channel element allocation for the CORESET #0 based on: i) the lowest resource block, and ii) the valid resource blocks, of the CORESET #0.

In an example, the apparatus is caused to perform: using the determined CORESET #0 to communicate with the network node.

In an example, the apparatus is caused to perform: in response to detecting the primary and secondary synchronisation signals, demodulating and decoding the associated physical broadcast channel.

In an example, the physical broadcast channel is associated with the detected primary and secondary synchronisation signals.

In an example, the determining valid resource blocks for the CORESET #0 comprises: determining that the valid resource blocks for the CORESET #0 are the resource blocks with full control channel elements.

In an example, the determining valid resource blocks for the CORESET #0 comprises: determining that the valid resource blocks for the CORESET #0 are the resource blocks that cover fifteen resource blocks, with full and partial control channel elements.

In an example, the determining the size of the CORESET #0 comprises one of: determining a maximum number of full control channel elements that fit into fifteen resource blocks; determining a maximum number of full and partial control channel elements that fit into fifteen resource blocks; determining a number of full control channel elements using a predetermined number of control channel elements; determining a number of resource blocks using predefined multiple of six resource blocks, that is above a total of fifteen resource blocks.

In an example, the determining a control channel element allocation for the CORESET #0 comprises: determining the control channel element allocation for the CORESET #0 using non-interleaved control channel element mapping.

In an example, the apparatus is caused to perform: in response to determining the valid resource blocks for the CORESET #0, determining, using the physical broadcast channel, an index that provides information about control channel element allocation within the valid resource blocks of the CORESET #0.

In an example, the apparatus is caused to perform: receiving, from the network node, a configuration associated with the physical downlink control channel; and in response to the receiving, determining the CORESET #0 for all search spaces using the CORESET #0 in an initial bandwidth part.

In an example, the apparatus is caused to perform: receiving, from the network node, a configuration associated with the physical downlink control channel; and after receiving the configuration, using parameters comprised within the configuration to determine a further CORESET #0 that is applied for all other search spaces using CORESET #0 except a Type0 PDCCH search space, wherein the further CORESET #0 used by the other search spaces is wider, in frequency, than the CORESET #0 used by Type0-PDCCH, wherein the further CORESET #0 comprises the resource blocks used by the CORESET #0 applied for Type0 PDCCH search space.

In an example, the apparatus is caused to perform: receiving, from the network node, a configuration associated with the physical downlink control channel; and using one or more parameters comprised within the configuration associated with the physical downlink control channel to determine whether one of: a lower edge in frequency, or a higher edge in frequency, of the CORESET #0 is to be aligned with resource blocks of the physical broadcast channel.

In an example, the apparatus is caused to perform: determining a channel bandwidth that the network node is operating with using the detected primary and secondary synchronisation signals.

In an example, the determining comprises: determining a synchronisation raster point using the detected primary and secondary synchronisation signals so to determine the channel bandwidth that the network node is operating with.

In an example, the channel bandwidth is determined to be three megahertz.

In an example, there are fifteen resource blocks available for the physical broadcast channel.

In an example, one of: the apparatus is for a user equipment, the apparatus is located within the user equipment, or the apparatus is the user equipment.

According to an aspect, there is provided a method comprising: detecting a primary synchronisation signal and a secondary synchronisation signal transmitted from a network node; using the detected primary and secondary synchronisation signals to determine a number of resource blocks allocated for a physical broadcast channel; determining a lowest resource block, in frequency, of the physical broadcast channel; and determining a lowest resource block, in frequency, for a control resource set 0, CORESET #0, to be the same as the determined lowest resource block of the physical broadcast channel.

In an example, the determining the lowest resource block, in frequency, on which the physical broadcast channel was transmitted comprises: determining the lowest resource block, in frequency, on which the physical broadcast channel was transmitted, from the network node, after a puncturing of the resource blocks.

In an example, the method comprises: determining valid resource blocks for the CORESET #0 by aligning with valid resource blocks of the physical broadcast channel in order to determine a size of the CORESET #0; and determining a control channel element allocation for the CORESET #0 based on: i) the lowest resource block, and ii) the valid resource blocks, of the CORESET #0.

In an example, the method comprises: using the determined CORESET #0 to communicate with the network node.

In an example, the method comprises: in response to detecting the primary and secondary synchronisation signals, demodulating and decoding the associated physical broadcast channel.

In an example, the physical broadcast channel is associated with the detected primary and secondary synchronisation signals.

In an example, the determining valid resource blocks for the CORESET #0 comprises: determining that the valid resource blocks for the CORESET #0 are the resource blocks with full control channel elements.

In an example, the determining valid resource blocks for the CORESET #0 comprises: determining that the valid resource blocks for the CORESET #0 are the resource blocks that cover fifteen resource blocks, with full and partial control channel elements.

In an example, the determining the size of the CORESET #0 comprises one of: determining a maximum number of full control channel elements that fit into fifteen resource blocks; determining a maximum number of full and partial control channel elements that fit into fifteen resource blocks; determining a number of full control channel elements using a predetermined number of control channel elements; determining a number of resource blocks using predefined multiple of six resource blocks, that is above a total of fifteen resource blocks.

In an example, the determining a control channel element allocation for the CORESET #0 comprises: determining the control channel element allocation for the CORESET #0 using non-interleaved control channel element mapping.

In an example, the method comprises: in response to determining the valid resource blocks for the CORESET #0, determining, using the physical broadcast channel, an index that provides information about control channel element allocation within the valid resource blocks of the CORESET #0.

In an example, the method comprises: receiving, from the network node, a configuration associated with the physical downlink control channel; and in response to the receiving, determining the CORESET #0 for all search spaces using the CORESET #0 in an initial bandwidth part.

In an example, the method comprises: receiving, from the network node, a configuration associated with the physical downlink control channel; and after receiving the configuration, using parameters comprised within the configuration to determine a further CORESET #0 that is applied for all other search spaces using CORESET #0 except a Type0 PDCCH search space, wherein the further CORESET #0 used by the other search spaces is wider, in frequency, than the CORESET #0 used by Type0-PDCCH, wherein the further CORESET #0 comprises the resource blocks used by the CORESET #0 applied for Type0 PDCCH search space.

In an example, the method comprises: receiving, from the network node, a configuration associated with the physical downlink control channel; and using one or more parameters comprised within the configuration associated with the physical downlink control channel to determine whether one of: a lower edge in frequency, or a higher edge in frequency, of the CORESET #0 is to be aligned with resource blocks of the physical broadcast channel.

In an example, the method comprises: determining a channel bandwidth that the network node is operating with using the detected primary and secondary synchronisation signals.

In an example, the determining comprises: determining a synchronisation raster point using the detected primary and secondary synchronisation signals so to determine the channel bandwidth that the network node is operating with.

In an example, the channel bandwidth is determined to be three megahertz.

In an example, there are fifteen resource blocks available for the physical broadcast channel.

In an example, the method is performed by a user equipment.

According to an aspect, there is provided a computer program comprising instructions, which when executed by an apparatus, cause the apparatus to perform at least the following: detecting a primary synchronisation signal and a secondary synchronisation signal transmitted from a network node; using the detected primary and secondary synchronisation signals to determine a number of resource blocks allocated for a physical broadcast channel; determining a lowest resource block, in frequency, of the physical broadcast channel; and determining a lowest resource block, in frequency, for a control resource set 0, CORESET #0, to be the same as the determined lowest resource block of the physical broadcast channel.

According to an aspect, there is provided a computer program comprising instructions stored thereon for performing at least the following: detecting a primary synchronisation signal and a secondary synchronisation signal transmitted from a network node; using the detected primary and secondary synchronisation signals to determine a number of resource blocks allocated for a physical broadcast channel; determining a lowest resource block, in frequency, of the physical broadcast channel; and determining a lowest resource block, in frequency, for a control resource set 0, CORESET #0, to be the same as the determined lowest resource block of the physical broadcast channel.

According to an aspect, there is provided a non-transitory computer readable medium comprising program instructions, that, when executed by an apparatus, cause the apparatus to perform at least the following: detecting a primary synchronisation signal and a secondary synchronisation signal transmitted from a network node; using the detected primary and secondary synchronisation signals to determine a number of resource blocks allocated for a physical broadcast channel; determining a lowest resource block, in frequency, of the physical broadcast channel; and determining a lowest resource block, in frequency, for a control resource set 0, CORESET #0, to be the same as the determined lowest resource block of the physical broadcast channel.

A computer product stored on a medium may cause an apparatus to perform the methods as described herein.

A non-transitory computer readable medium comprising program instructions, that, when executed by an apparatus, cause the apparatus to perform the methods as described herein.

An electronic device may comprise apparatus as described herein.

In the above, various aspects have been described. It should be appreciated that further aspects may be provided by the combination of any two or more of the various aspects described above.

Various other aspects and further embodiments are also described in the following detailed description and in the attached claims.

According to some aspects, there is provided the subject matter of the independent claims. Some further aspects are defined in the dependent claims. The embodiments that do not fall under the scope of the claims are to be interpreted as examples useful for understanding the disclosure.

### List of Abbreviations

AF: Application Function
AL: Aggregation Level
AMF: Access Management Function
AN: Access Network
BD: Blind Detection
BS: Base Station
BW: Bandwidth
CBW: Channel Bandwidth
CCE: Control Channel Element
CORESET: Control Resource Set
CN: Core Network
DL: Downlink
DMRS: Demodulation Reference Signal
eNB: eNodeB
FR1: Frequency Range 1
FRMCS: Future Railway Mobile Communication System
gNB: gNodeB
GSCN: Global Synchronisation Channel Number
GSM-R: Global System for Mobile Communications-Railway
IIOT: Industrial Internet of Things
LTE: Long Term Evolution
MS: Mobile Station
MIB: Master Information Block
NEF: Network Exposure Function
NG-RAN: Next Generation Radio Access Network
NF: Network Function
NR: New Radio
NRF: Network Repository Function
NW: Network
PBCH: Physical Broadcast Channel
PDCCH: Physical Downlink Control Channel
PCF Policy Control Function
PLMN: Public Land Mobile Network
PRB: Physical Resource Block
PSS: Primary Synchronisation Signal
RAN: Radio Access Network
RE: Resource Element
REG: Resource Element Group
RF:
SCS:
SI:
Radio Frequency
Subcarrier Spacing
System Information
SIB: System Information Block
SMF: Session Management Function
SS: Synchronisation Signal
SSB: Synchronization Signal Block
SSREF: Frequency position of the Synchronisation Signal
SSS: Secondary Synchronisation Signal
UE: User Equipment
UDR: Unified Data Repository
UDM: Unified Data Management
UL: Uplink
UPF: User Plane Function
3GPP: 3rd Generation Partnership Project
5G: 5th Generation
5GC: 5G Core network
5G-AN: 5G Radio Access Network
5GS: 5G System

### DESCRIPTION OF FIGURES

Embodiments will now be described, by way of example only, with reference to the accompanying Figures in which:

FIG. 1 shows a schematic representation of a 5G system;

FIG. 2 shows a schematic representation of a control apparatus;

FIG. 3 shows a schematic representation of a terminal;

FIG. 4 shows a schematic representation of the existing new radio initial access signals and channels with a 15 kHz subcarrier spacing;

FIG. 5 shows a schematic representation of a different puncturing patterns for a synchronization signal block;

FIG. 6 shows an example representation of CORESET resource allocation including resource block offsetting;

FIG. 7 shows a schematic representation of a CORESET 0 configuration within a 22 physical resource blocks initial bandwidth part;

FIG. 8a shows another schematic representation of a CORESET 0 configuration within an initial bandwidth part of 20 physical resource blocks, with an offset of 2 control channel elements;

FIG. 8b shows another schematic representation of a CORESET 0 configuration within an initial bandwidth part of 24 physical resource blocks, with an offset of 2 control channel elements;

FIGS. 9a and 9b show schematic representations of alignments between valid physical resource blocks of a physical broadcast channel with valid physical resource blocks of CORESET 0;

FIG. 10 shows a schematic representation of CORESET 0 size determination and CCE allocation options;

FIG. 11 shows another example method flow diagram performed by a user equipment; and

FIG. 12 shows a schematic representation of a non-volatile memory medium storing instructions which when executed by a processor allow a processor to perform one or more of the steps of the method of FIG. 11.

### DETAILED DESCRIPTION

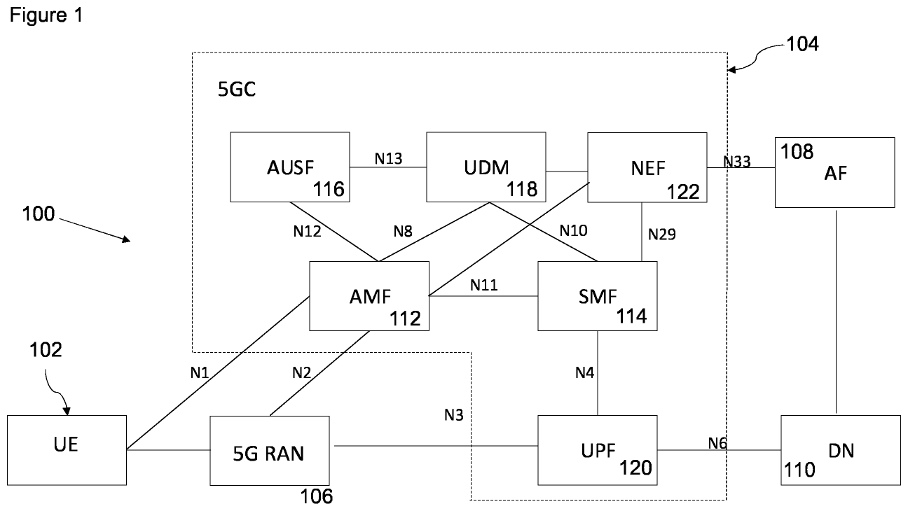

Before explaining in detail some examples of the present disclosure, certain general principles of a wireless communication system and mobile communication devices are briefly explained with reference to FIGS. 1 to 3 to assist in understanding the technology underlying the described examples.

In a wireless communication system 100, such as that shown in FIG. 1, mobile communication devices/terminals or user apparatuses, and/or user equipments (UEs), and/or machine-type communication devices 102 are provided wireless access via at least one base station (not shown) or similar wireless transmitting and/or receiving node or point. A communication device is provided with an appropriate signal receiving and transmitting apparatus for enabling communications, for example enabling access to a communication network or communications directly with other devices. The communication device may access a carrier provided by a station or access point, and transmit and/or receive communications on the carrier.

In the following certain examples are explained with reference to mobile communication devices capable of communication via a wireless cellular system and mobile communication systems serving such mobile communication devices. Before explaining in detail the examples of the disclosure, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS) 100. The 5GS may comprise a device 102 such as user equipment or terminal, a 5G radio access network (5G-RAN) 106, a 5G core network (5GC) 104, one or more network functions (NF), one or more application function (AF) 108 and one or more data networks (DN) 110.

The 5G-RAN 106 may comprise one or more gNodeB (gNB) distributed unit functions connected to one or more gNodeB (gNB) centralized unit functions.

The 5GC 104 may comprise an access management function (AMF) 112, a session management function (SMF) 114, an authentication server function (AUSF) 116, a user data management (UDM) 118, a user plane function (UPF) 120, a network exposure function (NEF) 122 and/or other NFs. Some of the examples as shown below may be applicable to 3GPP 5G standards, including 5G-Advanced. However, some examples may also be applicable to 4G, 3G and other 3GPP standards.

In a communication system, such as that shown in FIG. 1, mobile communication devices/terminals or user apparatuses, and/or user equipments (UE), and/or machine-type communication devices are provided with wireless access via at least one base station or similar wireless transmitting and/or receiving node or point. The terminal is provided with an appropriate signal receiving and transmitting apparatus for enabling communications, for example enabling access to a communication network or communications directly with other devices. The communication device may access a carrier provided by a base station or access point, and transmit and/or receive communications on the carrier.

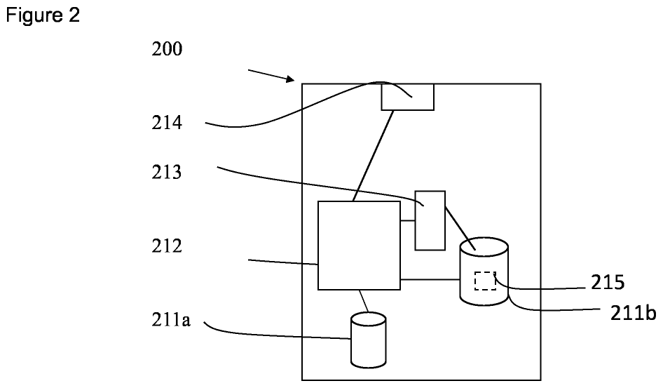

FIG. 2 illustrates an example of a control apparatus 200 for controlling a function of the 5G-RAN or the 5GC as illustrated on FIG. 1. The control apparatus may comprise at least one random access memory (RAM) 211a, at least one read only memory

(ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5G-AN or the 5GC. In some examples, each function of the 5G-AN or the 5GC comprises a control apparatus 200. In alternative examples, two or more functions of the 5G-AN or the 5GC may share a control apparatus.

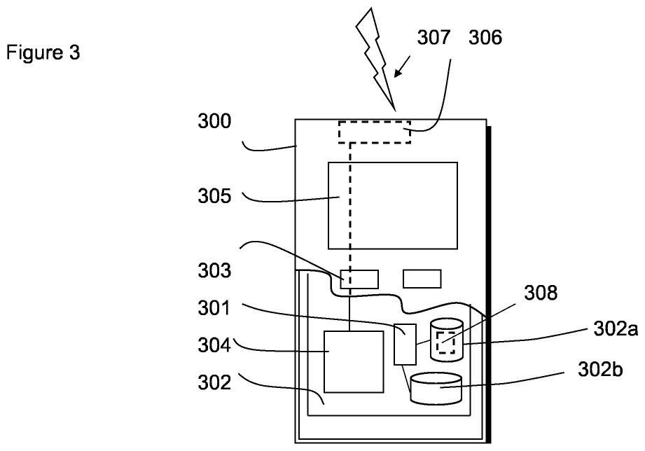

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIoT) device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3, a transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus may be provided on an appropriate circuit board and/or in chipsets. This feature is denoted by reference 304. The device may optionally have a user interface such as keypad 305, touch sensitive screen or pad, combinations thereof or the like. Optionally one or more of a display, a speaker and a microphone may be provided depending on the type of the device.

One or more of the following examples are application to, or related to, narrowband New Radio operation (NB NR), which includes NR support for dedicated spectrum less than 5 MHz. This is an emerging scenario driven by the need for, for example, railway communications (globally), smart grid operators in the USA, and public safety in Europe.

Future railway mobile communication system (FRMCS) in Europe has the following considerations: Agreed to use NR on 2×5.6 MHz FDD (874.4-880 MHz/919.4-925 MHz) frequency band, soft migration from Global System for Mobile Communications-Railway (GSM-R) requires parallel operation of GSM-R and NR on the band, and is expected to last approx. 10 years (˜2025-˜2035). In some scenarios it is assumed that NR may be allocated the 3 MHz channel. Potential deployment scenarios include, for NR downlink (DL)/uplink (UL) and GSM-R DL/UL: an adjacent channel deployment, an overlay deployment with compact GSM-R channel placement, an overlay deployment with GSM-R channels distributed over 4 MHz core band, and an overlay deployment with GSM-R channels distributed over full extended railways GSM (ER-GSM) band. An adjacent channel deployment of NR and GSM-R may have advantages of an easier implementation for NR scheduler, and only one boundary between NR and GSM-R leading to a simpler and more predictable co-existence.

Narrowband NR has also been considered for ‘Smart grids’ including 2×3 MHz frequency division duplexing (FDD) in 900 MHz in the USA. NB NR has also been considered for public safety applications including 2×3 MHz FDD in band 28 for public protection and disaster relief (PPDR) in Europe.

In NR Rel-15 to Rel-17 channel bandwidths (CBWs) under 5 MHz are not currently supported. It has been proposed to adapt NR to the 3-5 MHz spectrum allocations with minimal changes, building on the existing NR ecosystem.

It has been identified that there are scenarios that are emerging in which it may be beneficial to enable the operation of 5G NR in a narrower bandwidth than the 5 MHz channels for which it was originally designed. For example, operation down to 3 MHz. For example, deployment of NR in the 900 MHz future railway mobile communication system (FRMCS) band is to operate alongside any legacy GSM-R carriers within a 5.6 MHz bandwidth, which permits approximately 3.6 MHz bandwidth to be used for NR. Similarly, there may be some cases whereby 3 MHz channels are available for NR.

However, one or more of the signals and channels transmitted by the NR base stations (gNBs), including signals and channels of the synchronization signal and physical broadcast channel (PBCH) block, were not designed for transmission in such narrow channels.

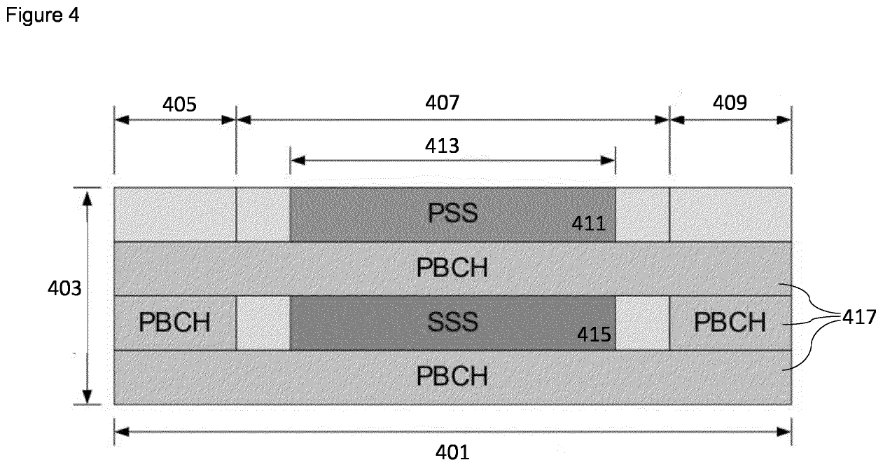

FIG. 4 shows a schematic representation of the existing NR initial access signals and channels with a 15 kHz subcarrier spacing.

There is provided a block with a width (frequency domain) of 240 subcarriers (SCs) 401, which equates to 20 physical resource blocks (PRBs). Each PRB comprising 12 SCs. The block has height (time domain) of 4 orthogonal frequency division multiplex (OFDM) symbols 403.

The total of 240 SCs 401 is split into a first bandwidth 405, a second bandwidth 407, and a third bandwidth 409. The first bandwidth 405 is 0.72 MHz and 48 SCs (i.e. 4 PRBs). The second bandwidth 407 is 2.16 MHz and 144 SCs (i.e. 12 PRBs). The third bandwidth 409 is 0.72 MHz and 48 SCs (i.e. 4 PRBs). In this way, the total bandwidth is 3.6 MHz.

In one of the 4 OFDM symbols there is a primary synchronisation signal (PSS) 411, which is 127 SCs 413. In another one of the 4 OFDM symbols there is a secondary synchronisation signal (SSS) 415 which is also 127 SCs 413.

A PBCH 417 is provided in three of the OFDM symbols. PBCH is provided across all SCs of the block in some OFDM symbols, and across a partial number of SCs of the total SCs in another of the OFDM symbols.

A UE may receive the signals and channels as shown in FIG. 4. After detecting the PSS and SSS, the UE may know, in addition to a physical cell identity (ID) (of the cell that sent the signals), a slot timing within a 5 millisecond (ms) half frame and symbol timing. The UE may then determine resource elements (REs) for the PBCH demodulation reference signal (DMRS) and data to receive the PBCH payload. The PBCH carries a master information block (MIB) signalling the system information related to the frequency position (synchronization signal block frequency domain allocation related to a common resource block (CRB) grid) and timing (half frame timing, and frame timing). The information may be contained either in higher layer payload (i.e. MIB), as a part of the physical layer bits in the transport block payload, or in DMRS.

A 3 MHz allocation to the NR system would equate to a maximum 15 PRB channel bandwidth. This would be assuming a 90% spectrum utilization. For a synchronization signal block (SSB) this would lead to a 5 PRB puncturing. Puncturing of transmitted signals is used to narrow down a transmission bandwidth with minimum change. In a puncturing operation, a base station blanks any signals mapped on certain predefined PRBs that fall outside a desired transmission bandwidth. In this way, the base station will not transmit those signals. When a UE receives the transmission with punctured PRBs, the UE may null the punctured PRBs at the receiver. The UE may null the punctured PRBs by, for example, setting the log-likelihood ratios (LLRs) to zero in the channel decoder.

In other examples, if UE is not aware of punctured PRBs, a UE may receive the transmission on all PRBs used for the transmission, including the punctured PRBs.

An alternative to puncturing is rate matching, whereby input bits are matched to the available resources. Due to that, the sequence of rate matched bits varies according to the resource size. With rate matching a receiver should know the resource size, in order to decode the packet correctly.

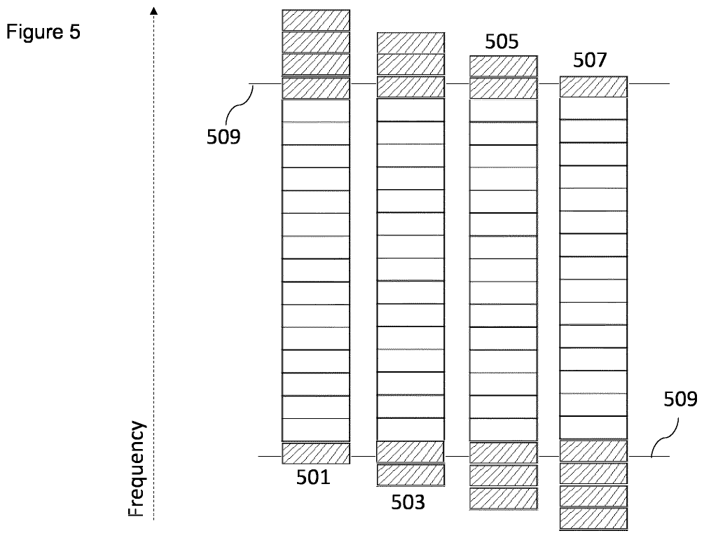

Since PSS/SSS should remain unaffected, in some examples, a maximum of 4 PRB puncturing per side of the SSB may take place. In other words, some applicable puncturing patterns for 5 PRB puncturing include 1+4, 2+3, 3+2, 4+1 as illustrated in FIG. 5.

As mentioned above, FIG. 4 shows signals and channels with a 15 kHz subcarrier spacing. Compared to other SCSs supported by NR, a 15 kHz subcarrier spacing (SCS) provides the smallest bandwidth (in MHz) for signals defined by a predefined number of RBs (such as, for example, PBCH). In this way, a 15 kHz SCS is a suitable starting point when defining support for NR<5 MHz. It should be understood that the following examples may also be applied to subcarrier spacings above, or below 15 kHz.

FIG. 5 shows a schematic representation of a different puncturing patterns for a synchronization signal block.

There are shown four different puncturing patterns 501, 503, 505, 507. Each of the puncturing patterns 501, 503, 505, 507 is for an SSB with 20 PRBs. Each block in FIG. 5 represents a PRB. There are shown two puncturing lines 509 through the PRBs.

The puncturing line 509 intersects PRBs of the four different puncturing patterns 501, 503, 505, 507. Blocks that have no pattern (i.e. plain) indicates that they are transmitted. Blocks that have a pattern (i.e. the hatching) indicates that they are punctured.

A y-axis is shown which corresponds to frequency. The arrow of the y-axis indicates an increasing frequency.

In the first puncturing pattern 501, there is a ‘1+4’ pattern. The first PRB (i.e. PRB 0) and the final four PRBs (i.e. PRB 16 to PRB 19) are punctured. The remaining PRBs of the SSB are transmitted.

In the second puncturing pattern 503, there is a ‘2+3’ pattern. The first and second PRBs (i.e. PRB 0 and PRB 1) and the final three PRBs (i.e. PRB 17 to PRB 19) are punctured. The remaining PRBs of the SSB are transmitted.

In the third puncturing pattern 505, there is a ‘3+2’ pattern. The first three PRBs (i.e. PRB 0 to PRB 2) and the final two PRBs (i.e. PRB 18 and PRB 19) are punctured. The remaining PRBs of the SSB are transmitted.

In the fourth puncturing pattern 507, there is a ‘4+1’ pattern. The first four PRBs (i.e. PRB 0 to PRB 3) and the final PRB (i.e. PRB 19) are punctured. The remaining PRBs of the SSB are transmitted.

It should be understood that SSB bandwidths of 20 PRBs and 15 PRBs, respectively, are used as examples only. In other examples, other suitable lengths of SSBs may be punctured to other suitable lengths using the different puncturing patterns 501, 503, 505, 507.

Control resource set (CORESET) is a set of physical resources and a set of parameters that is used to carry physical downlink control channel (PDCCH)/downlink control information. It is conceptually equivalent, in function, to the LTE PDCCH area (the first 1,2,3,4 OFDM symbols in a subframe). In LTE PDCCH region, the PDCCH is spread across the whole channel bandwidth, but the NR CORESET region is localized to a specific region in frequency domain.

For a CORESET,

$${N}_{RB}^{CORESET}$$

is the number of resource blocks (RBs) in the frequency domain of the CORESET.

$${N}_{symb}^{CORESET}$$

is the number of symbols in the time domain of the CORESET.

$${N}_{REG}^{CORESET}$$

is the number of resource element groups (REGs) in a CORESET. L is the REG bundle size, which may be set by the parameter CORESET-REG-bundle-size.

A UE may receive the signals and channels as shown in FIG. 4. Firstly, the UE detects the PSS and SSS. Following this the UE demodulates/decodes the PBCH. The UE then reads a configuration index from the PBCH/MIB. The configuration index refers to a CORESET #0 configuration table (such as Table 1 below), and more specifically to certain time and frequency resource allocation parameters. One of the parameters defines the resource block (RB) offset between the first PRB of the CORESET #0 and the first PRB in which the first subcarrier of the SSB is located. This is shown in the fifth column of Table 1 below. The SSB is in the same subcarrier raster but not necessarily in the same RB raster as CORESET #0.

TABLE 1
Set of resource blocks and slot symbols of CORESET
for Type0-PDCCH search space set when {SS/PBCH
block, PDCCH} SCS is {15, 15} kHz for
frequency bands with minimum channel bandwidth 5 MHz or 10 MHz

| | SS/PBCH block and | Number of | Number of | |
|---|---|---|---|---|
| | CORESET multiplexing | RBs | Symbols | Offset |
| Index | pattern | N_{RB}^{CORESET} | N_{symb}^{CORESET} | (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 48 | 1 | 12 |
| 7 | 1 | 48 | 1 | 16 |
| 8 | 1 | 48 | 2 | 12 |
| 9 | 1 | 48 | 2 | 16 |
| 10 | 1 | 48 | 3 | 12 |
| 11 | 1 | 48 | 3 | 16 |
| 12 | 1 | 96 | 1 | 38 |
| 13 | 1 | 96 | 2 | 38 |
| 14 | 1 | 96 | 3 | 38 |

| | |
|---|---|
| 15 | Reserved |

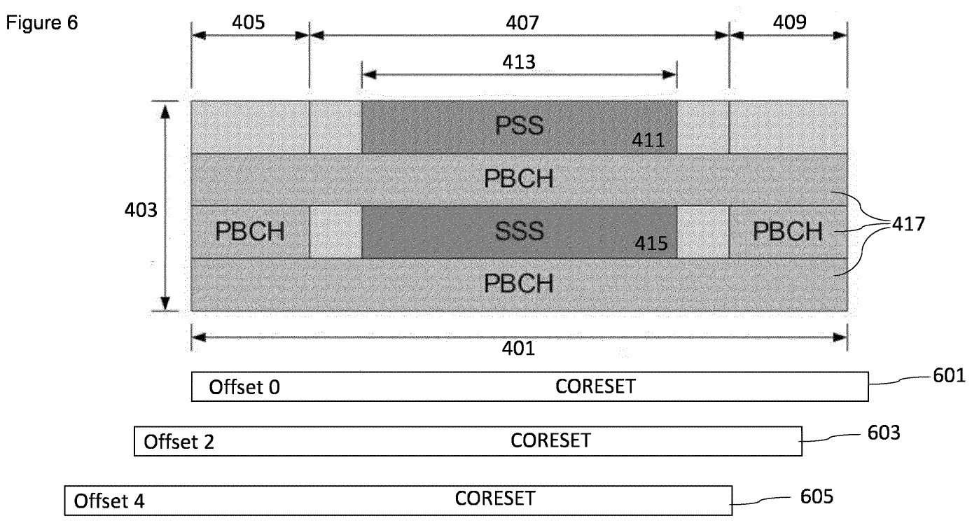

FIG. 6 shows an example representation of CORESET resource allocation including resource block offsetting.

There is provided the signals and channels in the block of FIG. 4. For ease, the same labelling is provided in FIG. 6 for this block, as is used in FIG. 4.

There is also provided a first CORESET configuration 601 which has an offset of 0. The offset of 0 may be determined from Table 1, for example, for index 0 or index 3. There is also provided a second CORESET configuration 603 which has an offset of 2. The offset of 2 may be determined from Table 1, for example, for index 1 or index 4. There is also provided a third CORESET configuration 605 which has an offset of 4. The offset of 4 may be determined from Table 1, for example, for index 2 or index 4. The offset is between the first PRB of the CORESET #0 and the first PRB in which the first subcarrier of the SSB is located (of the received block).

The SSB is in the same subcarrier raster as common RB grid but may not be aligned in RB level. Subcarrier offset between SSB and common RB grid is provided with the k_SSB parameter provided in MIB. It has the following characteristics: k SSB parameter in FRI has 5 bits with values 0 to 23 used to indicate subcarrier offset between SSB and common RB grid, and when SSB and CORESET #0 has the same SCS, values 0 to 11 are used.

There is a special type of coreset called CORESET 0, or CORESET #0. This CORESET is the one transmitting PDCCH for SIBI scheduling. There are many parameters involved in defining those CORESET and those parameters are specified by radio resource control (RRC) message. However, CORESET 0 cannot be specified by RRC since it should be used before any RRC message is transmitted. It implies that CORESET 0 should be configured by some predefined process and predefined parameters. Therefore, CORESET 0 is configured by a separate process and predefined parameters summarized in the table below.

TABLE 2
Parameters and values used to determine CORESET 0

| Parameters | Predefined value or process |
|---|---|
| Frequency/Time Resource | MIB pdcch-ConfigSIB1 (38.213-13) |
| Allocation | |
| Interleaving | Assumed Interleaving (38.211-7.3.2.2) |
| L (REG Bundle Size) | 6 (38.211-7.3.2.2) |
| R (Interleaver Size) | 2 (38.211-7.3.2.2) |
| n_shift (Shiftindex) | N_cellID (38.211-7.3.2.2) |
| Cyclic Prefix | Normal (38.211-7.3.2.2) |
| Precoding | Same Precoding used in REG Bundle |
| | (38.211-7.3.2.2) |

CORESET #0 may also be configured in PDCCH-ConfigCommon contained within SIB1. Alternatively, CORESET #0 may be configured to a UE with dedicated signalling. In these cases, configuring may be done with a 4-bit value indicating to the same table as the index provided in the MIB.

As CORESET 0 is not configured using RRC signalling, it may be difficult to derive a CORESET 0 configuration in scenarios below 5 MHz. In particular, in NR scenarios below 5 MHz. In some systems, mechanisms to address these scenarios involves increased complexity at the UEs and/or significant proposed changes to current standards/specifications. One or more of the following examples aims to minimize the complexity related to determining CORESET 0 configuration. In particular, for scenarios involving PBCH bandwidth smaller than 20 RBs.

In examples, there is a provided a method whereby, when determining a CORESET 0 (CORESET #0) configuration, a UE determines the lowest RB (in frequency) for the CORESET 0 configuration based on a determined lowest resource block (in frequency) of a PBCH.

The lowest RB of the PBCH may be the lowest RB on which the PBCH was transmitted on, by the network. The lowest RB of the PBCH may be lowest RB on which PBCH is transmitted after puncturing of the resource blocks, in some examples. This determination of the lowest RB may be achieved due to a (new) interpretation of the “Offset (RBs)” parameter, in Table 1 above. This will be described in more detail below.

In some examples, it may be assumed that, when determining the CORESET 0 configuration in this manner, the channel bandwidth is 3 MHz. However, it should be understood that in some other examples, the CBW may be higher, or lower, than 3 MHz. The UE may determine the CBW after detecting the SSB. This may allow the UE to determine that the associated network node/cell operates according to a 3 MHz channel bandwidth (CBW). The CBW may be determined, by the UE, from a determined synchronization raster point. In the example of a 3 MHz CBW, based on this determination, the UE knows that there are valid 15 RBs available for PBCH.

This determination of the CORESET 0 configuration will be described in more detail below.

In some examples, when determining valid PRBs for the CORESET 0 configuration, the determination is made from among the RBs that are valid for the PBCH, and the RBs that are defined to be valid for CORESET 0 are defined by one of: i) valid PRBs for CORESET 0 are those with full control channel elements (CCEs), and ii) valid PRBs for CORESET 0 cover 15 PRBs (with full and partial CCEs). For both options, the same outcome may be reached when the number of symbols in the time domain of CORESET 0 equals two. With CORESET 0, a considered REG bundle size is 6. Hence, one CCE is either 2 symbols by 3 RBs, or 3 symbols by 2 RBs. A ‘full’ CCE is, when defining the valid RBs for CORESET0, those that are defined with the resolution of: 3

RBs for 2 symbol CORESET, or 2 RBs for 3 symbol CORESET.

In some examples, when determining the CORESET 0 configuration, a CORESET 0 size is modified by one of the following alternatives. The modification of the size may occur at least when monitoring predefined search spaces. Examples of predefined search spaces include Type0_PDCCH, Type0A_PDCCH, and Type2_PDCCH. The alternatives for CORESET 0 size comprises one of: i) a number of RBs (in the frequency domain of the CORESET 0 configuration, i.e.

$${N}_{RB}^{CORESET} )$$

is determined according to maximum number of full CCEs that fit to 15 PRBs, ii) the number of RBs

$$( {N}_{RB}^{CORESET} )$$

is determined according to maximum number of (full or partial) CCEs that fit to 15 PRBs, iii) the number of RBs

$$( {N}_{RB}^{CORESET} )$$

is determined according to a predefined number of full CCEs (e.g. 8 CCEs), and iv) the number of RBs

$$( {N}_{RB}^{CORESET} )$$

is a predefined number multiple of 6RBs, that is above or equal to 15, (for example, 18 RBs).

In some examples, when determining the CORESET 0 configuration, the UE assumes that the involved CCEs follows a non-interleaved CCE/non-interleaved CCE mapping. PDCCH candidates comprises consecutive CCE indexes. Hence, the non-interleaved CCE result is a contiguous frequency allocation for a PDCCH candidate, which in turn can maximize the number of CCEs available for a PDCCH candidate when the bandwidth is limited. In current systems, only interleaved mapping is supported for CORESET #0. This is limiting the number of CCEs available per PDCCH candidate for 3 MHz bandwidth (15 RBs).

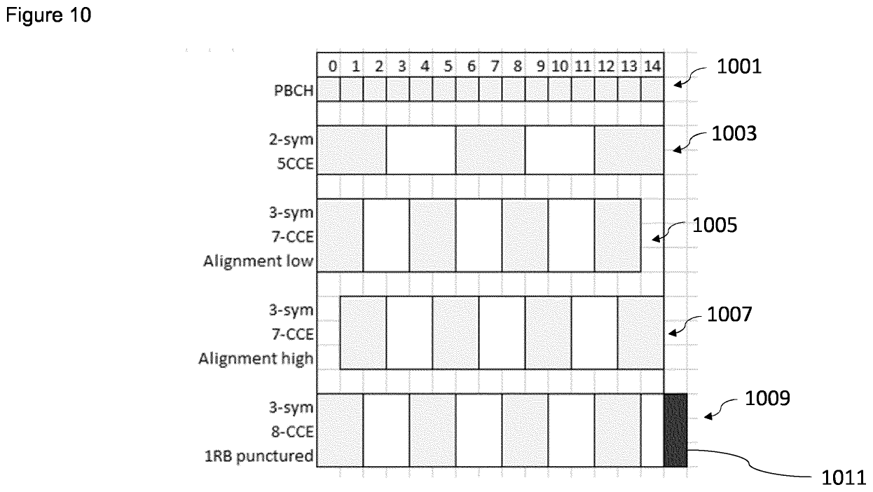

In some examples, after determining the valid PRBs for the CORESET 0 configuration, the UE determines, from the PBCH, an index that provides UE information about the CCE allocation within the valid PRBs. The PBCH provides an index to predefined options including: 2-symbol CORESET, 3 symbol CORESET (full CCE), 3 symbol CORESET (full) CCE with 1RB offset, 3 symbol CORESET (partial CCE). This is shown in more detail in FIG. 10.

In some example, after receiving a PDCCH-ConfigCommon, the UE determines the CORESET 0 configuration according to one of: a) the same CORESET 0 determination (as described above) is used for all search spaces using CORESET 0 in the initial bandwidth part (BWP), b) for initial BWP search spaces other than Type0_PDCCH but using CORESET 0, a wider CORESET 0 is defined. CORESET 0 is defined based on the controlResourceSetZero index in PDCCH-ConfigCommon with the following interpretations of Table 1 (shown above)

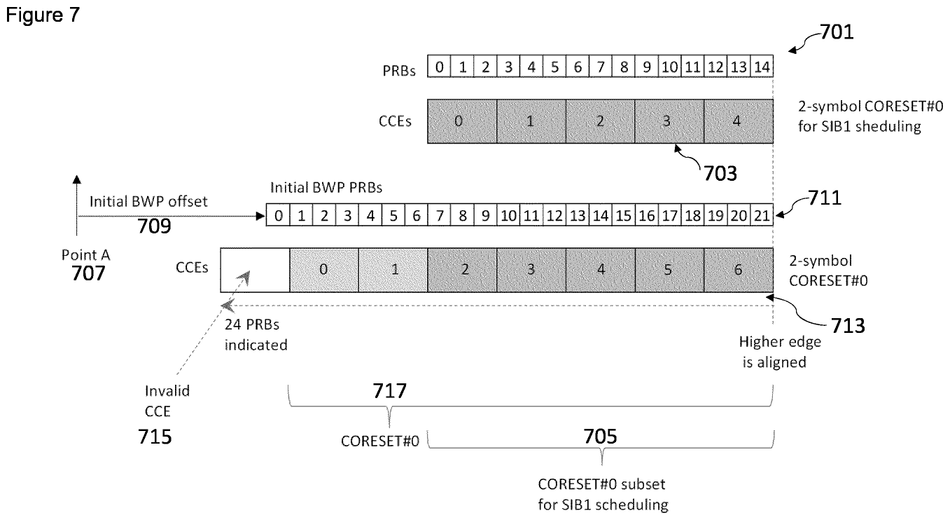

An ‘Offset (RBs)’ value of 0 (In Table 1) indicates that a lower edge of the CORESET 0 and the non-punctured PBCH RBs are aligned. An ‘Offset (RBs)’ value of 4 indicates that a higher edge of the CORESET 0 and the non-punctured PBCH RBs are aligned. This is described in more detail below and illustrated in FIG. 7.

An ‘Offset (RB)’ value of 2 (in Table 1) indicates a CCE offset between a lower edge of CORESET 0 and a lower edge of the non-punctured PBCH. The CCE offset is an integer value. For example, the integer value is two. In other examples, the integer value is higher than two.

For an example table with alternative values to Table 1, an ‘Offset (RB)’ value of 1 may indicate a CCE offset between a lower edge of CORESET 0 and a lower edge of the non-punctured PBCH. The CCE offset being an integer value. For example, the integer value is one. This can be seen in configuration 1007 of FIG. 10, which will be described in further detail below. In other examples, the integer value is higher than one. This offset maintains a CCE alignment with Type0_PDCCH CORESET 0 while substantially centering the CORESET #0 resources (with respect to the PBCH).

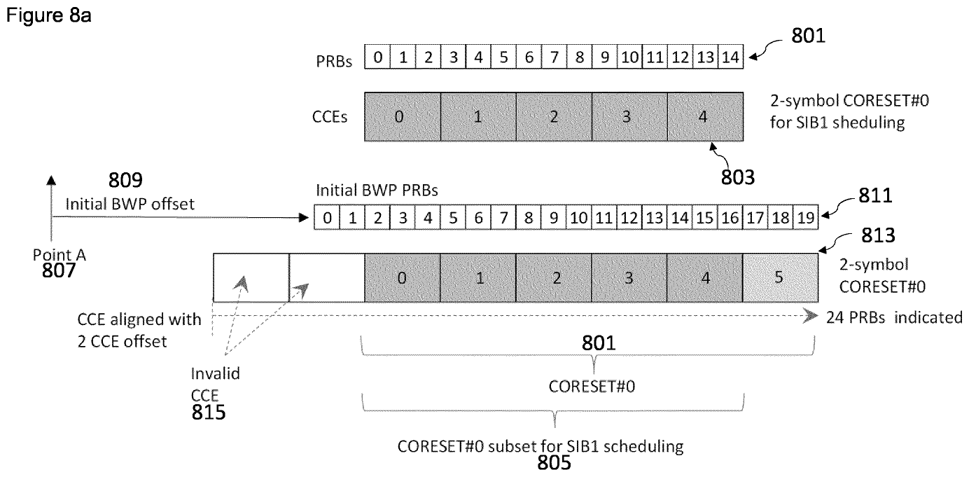

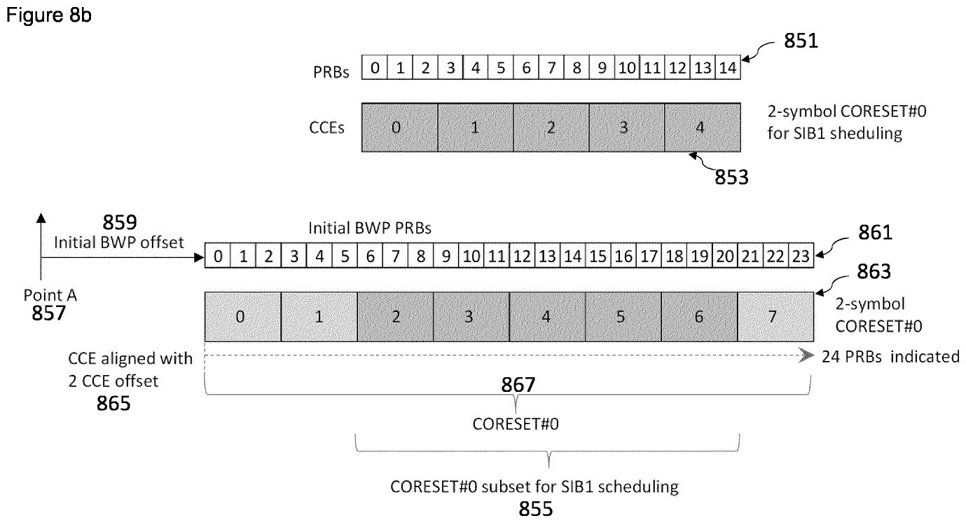

The number of RBs (i.e. ‘Offset (RBs)’) as indicated in Table 1 may be reduced in some examples, to the number of valid RBs of the initial BWP. Valid PRBs may be defined according to options a) and b) as defined above, and applied to the RBs of the initial BWP. An offset of 2 CCEs with option a) above, for valid RB, is illustrated in FIG. 8.

FIG. 7 shows a schematic representation of a CORESET 0 configuration within a 22 PRB initial BWP.

FIG. 7 shows a 15 PRB channel bandwidth (CBW) 701. The 15 PRB CBW 701 is equivalent to the PBCH. A sequence of 5 CCEs 703 are aligned, at the lower and the higher edge, with the 15 PRB CBW 701. The 5 CCEs 703 are a (2-symbol) CORESET 0 subset available for SIBI scheduling 705.

A ‘point A’ labelled 707 is provided. An initial BWP offset 709 is provided from ‘point A’ to initial BWP PRBs 711. The initial BWP PRBs are 22 PRBs in length. A higher edge of the initial BWP PRBs is aligned with the 15 PRB CBW 701 and the 5 CCEs 703.

A 2-symbol CORESET 0 configuration 713 is provided which comprises 7

CCEs and an invalid CCE 715 (at the lowest frequency). 7 CCEs and 1 invalid CCE is equivalent to 24 PRBs. The invalid CCE 715 is invalid as there is only a single PRB of the initial BWP 711 available, rather than the 3 PRBs needed for the CCE. In this way, a CORESET 0 configuration 717 comprises 7 CCEs (or 21 PRBs). The higher edge of the CORESET 0 configuration 717 is aligned with the 15 PRB CBW.

FIG. 8a shows another schematic representation of a CORESET 0 configuration within an initial BWP of 20 PRBs, with an offset of 2 CCEs.

As discussed above, an ‘Offset (RB)’ value of 2 indicates a CCE offset between a lower edge of CORESET 0 and a lower edge of the non-punctured PBCH. In the example of FIG. 8a, this CCE offset is 2.

FIG. 8a shows a 15 PRB CBW 801. A sequence of 5 CCEs 803 are aligned, at the lower edge and the higher edge, with the 15 PRB CBW 801. The 5 CCEs 803 are a (2-symbol) CORESET 0 subset for SIB1 scheduling 805.

A ‘point A’ labelled 807 is provided. An initial BWP offset 809 is provided from ‘point A’ to initial BWP PRBs 811. The initial BWP PRBs are 20 PRBs in length.

A 2-symbol CORESET 0 configuration 813 is provided which comprises 6 CCEs and two invalid CCEs 815 (at the lowest frequency). The invalid CCEs 815 are invalid as there is only two PRBs of the initial BWP 711 available, rather than the 6 PRBs needed for the two aligned CCEs.

In this way, a CORSET 0 configuration 817 comprises 6 CCEs (or 18 PRBs). The higher edge of the CORESET 0 configuration 817 is aligned with the 20 PRB initial BWP 811. There is a 2 CCE offset between the lower edge of the CORESET 0 configuration 817 and the lower edge of the 15 PRB CBW 801 and 5 CCEs 803.

FIG. 8b shows another schematic representation of a CORESET 0 configuration within an initial BWP of 24 PRBs, with an offset of 2 CCEs.

As discussed above, an ‘Offset (RB)’ value of 2 indicates a CCE offset between a lower edge of CORESET 0 and a lower edge of the non-punctured PBCH. In the example of FIG. 8b, this CCE offset is 2.

FIG. 8b shows a 15 PRB CBW 851. A sequence of 5 CCEs 853 are aligned, at the lower edge and the higher edge, with the 15 PRB CBW 851. The 5 CCEs 853 are a (2-symbol) CORESET 0 subset for SIB1 scheduling 855.

A ‘point A’ labelled 857 is provided. An initial BWP offset 859 is provided from ‘point A’ to initial BWP PRBs 861. The initial BWP PRBs are 24 PRBs in length.

A 2-symbol CORESET 0 configuration 863 is provided which comprises 8 CCEs. In this way, a CORSET 0 configuration 867 comprises 8 CCEs (or 24 PRBs). The lower and the higher edges of the CORESET 0 configuration 867 are aligned with the 24 PRB initial BWP 861. There is a 2 CCE offset 865 between the lower edge of the CORESET 0 configuration 867 and the lower edge of the 15 PRB CBW 851 and 5 CCEs 853.

As discussed above, there is provided a method whereby, when determining a CORESET 0 (CORESET #0) configuration, a UE determines the lowest PRB (in frequency) for the CORESET 0 configuration based on determined lowest resource block of a non-punctured PBCH. In the following example, it is assumed that the number of RBs for the CORESET 0 is 24. In other examples, more or less than 24 RBs are used for the CORESET 0. This determination of CORESET 0 by a UE, or another suitable device, may comprise one or more of the following steps:
i) Receiving, or detecting, initial access signals and/or channels from a network node. Such as, for example, those illustrated in FIG. 4.
ii) Upon detecting PSS and SSS on certain sync raster points, determining that the PBCH is transmitted using a 15 PRB allocation. This may mean that the UE can determine a certain puncturing pattern for the PBCH.
iii) Determining the lowest PRB (in frequency) for a CORESET 0, wherein the determining comprises setting the lowest PRB for CORESET 0 to be the same as the lowest RB of the non-punctured PBCH. Alternatively, an RB on a common grid having the subcarriers of the lowest RB of the non-punctured PBCH.
iv) Determining valid PRBs for the CORESET 0 based on the PBCH and the initial BWP. Determining the CORESET 0 size based on the PBCH and the initial BWP.
v) Determining the CCE allocation for the CORESET 0 based on the determination of the valid PRBs and the size of CORESET 0.

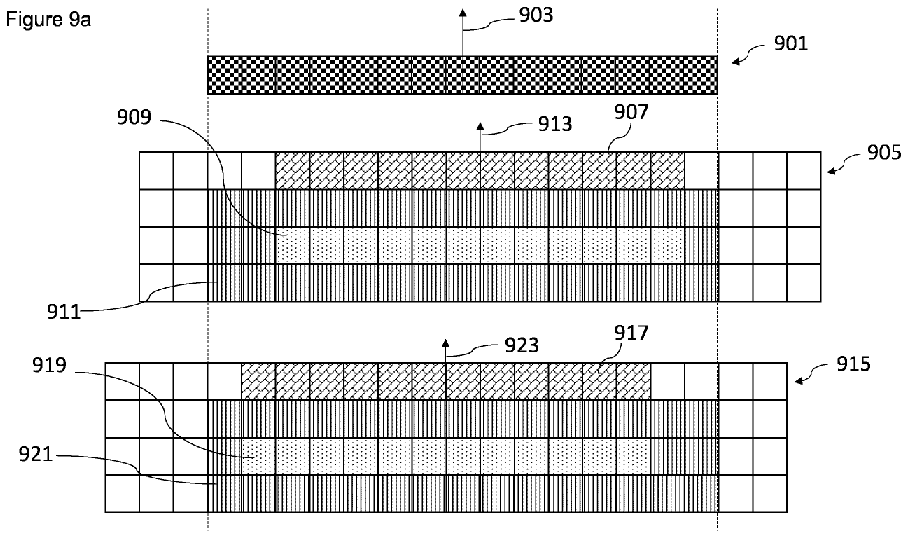

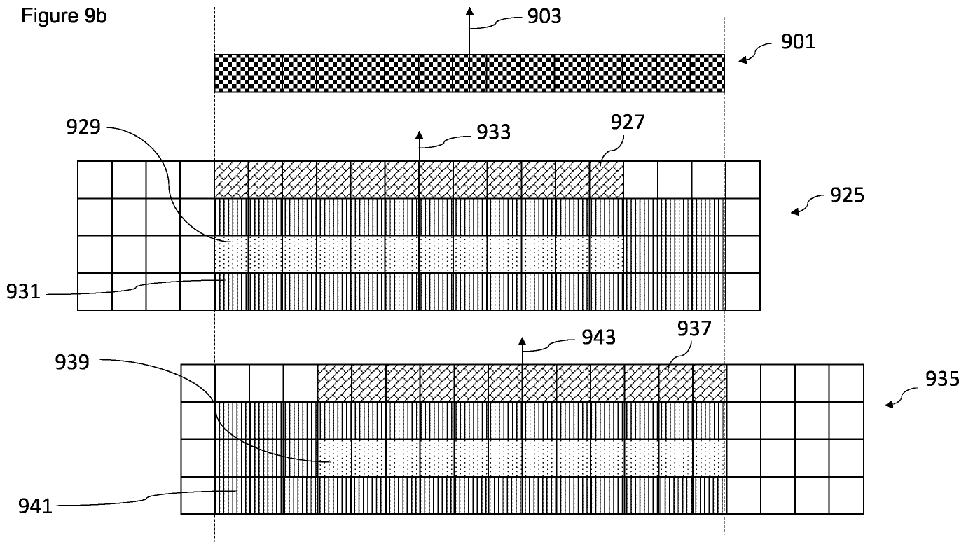

FIGS. 9a and 9b show schematic representations of alignments between valid PRBs of a PBCH with valid PRBs of CORESET 0. Each block/square in these figures represents a PRB.

Both FIGS. 9a and 9b show a 15 PRB common RB grid 901, as a reference. A channel raster point 903 is provided in the middle of the 15 PRBs, i.e. at 7.5 PRBs, in this example. Channel raster is in the middle of the carrier. Sync raster is in middle of PSS/SSS. The channel and sync raster may be in offset to each other.

For the blocks/squares, the checkerboard pattern represents common RBs. The brickwork pattern represents PSS. The dot pattern represents SSS. The vertical line pattern represents PBCH. The plain blocks represent punctured PRBs. The alignment between the options (and the PRBs) indicates an alignment in frequency between the options and the reference.

A first option 905 has a ‘2+3’ puncturing pattern. The first option 905 has a PSS 907 and a SSS 909, which each comprise 12 PRBs (each over 1 symbol). There is also provided a PBCH 911 with lower and higher edges aligned with the common RB grid 901. A sync raster point 913 of the first option 905 is offset from the channel raster 903 by +90 kHz, which is equivalent to 6 subcarriers (SCs).

A second option 915 has a ‘3+2’ puncturing pattern. The second option 915 has a PSS 917 and a SSS 919, which each comprise 12 PRBs (each over 1 symbol). There is also provided a PBCH 921 with lower and higher edges aligned with the common RB grid 901. A sync raster point 923 of the second option 915 is offset from the channel raster 903 by −90 kHz, which is equivalent to 6 subcarriers (SCs).

In FIG. 9b, a third option 925 has a ‘4+1’ puncturing pattern. The third option 925 has a PSS 927 and a SSS 929, which each comprise 12 PRBs (each over 1 symbol). There is also provided a PBCH 931 with lower and higher edges aligned with the common RB grid 901. A sync raster point 933 of the second option 925 is offset from the channel raster 903 by −270 kHz, which is equivalent to 18 subcarriers (SCs).

A fourth option 935 has a ‘1+4’ puncturing pattern. The fourth option 935 has a PSS 937 and a SSS 939, which each comprise 12 PRBs (each over 1 symbol). There is also provided a PBCH 941 with lower and higher edges aligned with the common RB grid 901. A sync raster point 943 of the second option 935 is offset from the channel raster 903 by +270 kHz, which is equivalent to 18 subcarriers (SCs).

FIG. 10 shows a schematic representation of CORESET 0 size determination and CCE allocation options.

There is provided a PBCH 1001. The PBCH comprises 15 RBs. A first CORESET 0 configuration 1003 comprises 2 symbols and 5 CCEs. Each CCE is equivalent to 3 PRBs. In this way, the first CORESET 0 configuration 1003 comprises 15 PRBs. The lower and higher edge of the first CORESET 0 configuration 1003 is aligned with the lower and higher edge of the PBCH 1001.

A second CORESET 0 configuration 1005 comprises 3 symbols and 7 CCEs. Each CCE is equivalent to 2 PRBs. In this way, the second CORESET 0 configuration 1005 comprises 14 PRBs. The lower edge of the second CORESET 0 configuration 1005 is aligned with the lower edge of PBCH 1001.

A third CORESET 0 configuration 1007 comprises 3 symbols and 7 CCEs. Each CCE is equivalent to 2 PRBs. In this way, the third CORESET 0 configuration 1007 comprises 14 PRBs. The higher edge of the second CORESET 0 configuration 1005 is aligned with the higher edge of PBCH 1001.

A fourth CORESET 0 configuration 1009 comprises 3 symbols and 8 CCEs. Each CCE is equivalent to 2 PRBs. In this way, the fourth CORESET 0 configuration 1009 comprises 16 PRBs. Due to the PBCH 1001 comprising 15 PRBs, one resource block is punctured 1011 (i.e. 16−15=1 RB). The lower edge of the second CORESET 0 configuration 1005 is aligned with the lower edge of PBCH 1001.

One or more of the examples above have the advantage that they have a small impact on the current specifications/standards. In particular for the 3 MHz scenario. A benefit of this approach is that there is no need for re-defining/changing Table 1, as included above (which is the same as Table 13-1 in 3GPP TS 38.213 specifications). In this case, it would be enough to have a new interpretation for certain rows in the Table (at minimum for indexes [0, 3].). Furthermore, one or more of the examples would lead to only small changes for the implementation, for example, changes to the interleaving pattern can be avoided. This leads to an optimal (and improved) performance. One or more of the examples enables candidate/CCE alignment with other CORESETs, which enables UE multiplexing.

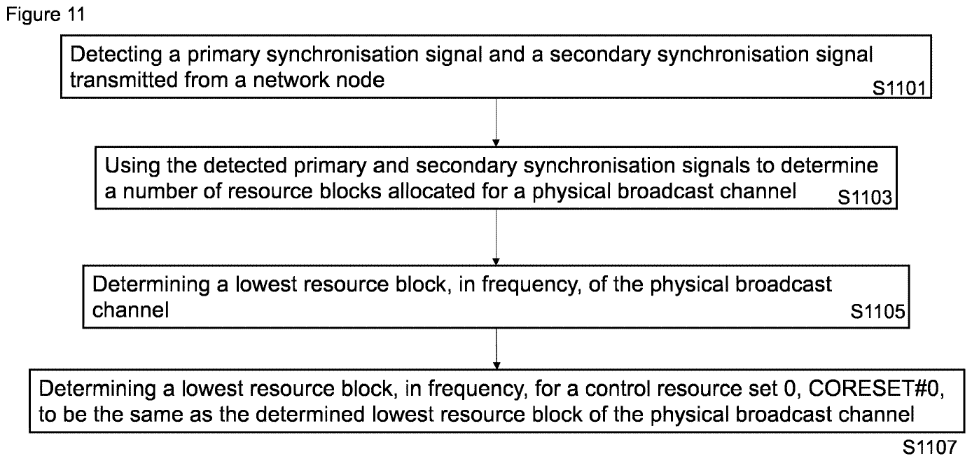

FIG. 11 shows an example method flow performed by an apparatus. The apparatus may be comprised within a user equipment. In an example, the apparatus may be a user equipment. In an example, the apparatus may be for a user equipment.

At S1101, the method comprises detecting a primary synchronisation signal and a secondary synchronisation signal transmitted from a network node.

At S1103, the method comprises using the detected primary and secondary synchronisation signals to determine a number of resource blocks allocated for a physical broadcast channel.

At S1105, the method comprises determining a lowest resource block, in frequency, of the physical broadcast channel.

At S1107, the method comprises determining a lowest resource block, in frequency, for a control resource set 0, CORESET #0, to be the same as the determined lowest resource block of the physical broadcast channel.

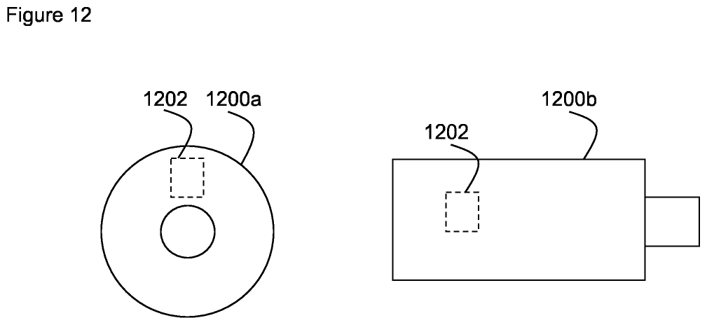

FIG. 12 shows a schematic representation of non-volatile memory media 1200a (e.g. computer disc (CD) or digital versatile disc (DVD)) and 1200b (e.g. universal serial bus (USB) memory stick) storing instructions and/or parameters 1202 which when executed by a processor allow the processor to perform one or more of the steps of the methods of FIG. 11.

It is noted that while the above describes example embodiments, there are several variations and modifications which may be made to the disclosed solution without departing from the scope of the present invention.

The examples may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The examples may be implemented by computer software stored in a memory and executable by at least one data processor of the involved entities or by hardware, or by a combination of software and hardware. Further in this regard it should be noted that any procedures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The term “non-transitory”, as used herein, is a limitation of the medium itself (i.e. tangible, not a signal) as opposed to a limitation on data storage persistency (e.g. RAM vs ROM).

As used herein, “at least one of the following: <a list of two or more elements>” and “at least one of: <a list of two or more elements>” and similar wording, where the list of two or more elements are joined by “and”, or “or”, mean at least any one of the elements, or at least any two or more of the elements, or at least all of the elements.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples.

Alternatively, or additionally some examples may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments. However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1. An apparatus comprising at least one processor, and at least one memory storing instructions that, when executed by the one or more processors, cause the apparatus to perform:
detecting a primary synchronisation signal and a secondary synchronisation signal transmitted from a network node;
using the detected primary and secondary synchronisation signals to determine a number of resource blocks allocated for a punctured physical broadcast channel;
determining a lowest resource block, in frequency, of the punctured physical broadcast channel; and
determining a lowest resource block, in frequency, for a control resource set 0, CORESET #0, of a physical downlink control channel, to be the same as the determined lowest resource block, in frequency, of the punctured physical broadcast channel.

2. The apparatus according to claim 1, wherein the instructions, when executed by the one or more processors, further cause the apparatus to perform:
determining valid resource blocks for the CORESET #0 of the physical downlink control channel by aligning with valid resource blocks of the punctured physical broadcast channel in order to determine a size of the CORESET #0 of the physical downlink control channel; and
determining a control channel element allocation for the CORESET #0 of the physical downlink control channel based on: i) the lowest resource block, and ii) the valid resource blocks, of the CORESET #0.

3. The apparatus according to claim 1, wherein the instructions, when executed by the one or more processors, further cause the apparatus to perform:
using the CORESET #0 of the physical downlink control channel to communicate with the network node.

4. The apparatus according to claim 2, wherein the instructions, when executed by the one or more processors, cause the apparatus to determine valid resource blocks for the CORESET #0 by:
determining that the valid resource blocks for the CORESET #0 of the physical downlink control channel are resource blocks with full control channel elements.

5. The apparatus according to claim 2, wherein the determining valid resource blocks for the CORESET #0 of the physical downlink control channel comprises:
determining that the valid resource blocks for the CORESET #0 of the physical downlink control channel are resource blocks that cover fifteen resource blocks, with full control channel elements and partial control channel elements.

6. The apparatus according to claim 2, wherein the instructions, when executed by the one or more processors, cause the apparatus to determine the size of the CORESET #0 of the physical downlink control channel comprises by one of:
determining a maximum number of full control channel elements that fit into fifteen resource blocks;
determining a maximum number of the full control channel elements and partial control channel elements that fit into the fifteen resource blocks;
determining a number of the full control channel elements using a predetermined number of control channel elements; or
determining a number of resource blocks using predefined multiple of six resource blocks, that is above a total of the fifteen resource blocks.

7. The apparatus according to claim 2, wherein the instructions, when executed by the one or more processors, cause the apparatus to determine the control channel element allocation for the CORESET #0 of the physical downlink control channel by:
determining the control channel element allocation for the CORESET #0 of the physical downlink control channel using non-interleaved control channel element mapping.

8. The apparatus according to claim 2, wherein the instructions, when executed by the one or more processors, further cause the apparatus to perform:
in response to determining the valid resource blocks for the CORESET #0 of the physical downlink control channel, determining, using the punctured physical broadcast channel, an index that provides information about the control channel element allocation within the valid resource blocks of the CORESET #0 of the physical downlink control channel.

9. The apparatus according to claim 2, wherein the instructions, when executed by the one or more processors, further cause the apparatus to perform:
receiving, from the network node, a configuration associated with the physical downlink control channel; and
in response to the receiving, determining the CORESET #0 for all search spaces of the physical downlink control channel using the CORESET #0 in an initial bandwidth part.

10. The apparatus according to claim 2, wherein the instructions, when executed by the one or more processors, further cause the apparatus to perform:
receiving, from the network node, a configuration associated with the physical downlink control channel; and
using one or more parameters comprised within the configuration associated with the physical downlink control channel to determine whether one of: a lower edge in frequency, or a higher edge in frequency, of the CORESET #0 of the physical downlink control channel is to be aligned with resource blocks of the punctured physical broadcast channel.

11. The apparatus according to claim 1, wherein the instructions, when executed by the one or more processors, further cause the apparatus to perform:
determining a channel bandwidth that the network node is operating with using the detected primary and secondary synchronisation signals.

12. The apparatus according to claim 11, wherein the instructions, when executed by the one or more processors, cause the apparatus to determine the channel bandwidth by determining a synchronisation raster point using the detected primary and secondary synchronisation signals so to determine the channel bandwidth that the network node is operating with.

13. The apparatus according to claim 1, wherein one of: the apparatus is for a user equipment, the apparatus is located within the user equipment, or the apparatus is the user equipment.

14. A method comprising:
detecting a primary synchronisation signal and a secondary synchronisation signal transmitted from a network node;
using the detected primary and secondary synchronisation signals to determine a number of resource blocks allocated for a punctured physical broadcast channel;
determining a lowest resource block, in frequency, of the punctured physical broadcast channel; and
determining a lowest resource block, in frequency, for a control resource set 0, CORESET #0, of the physical downlink control channel, to be the same as the determined lowest resource block, in frequency, of the punctured physical broadcast channel.

15. The method according to claim 14, further comprising:
determining valid resource blocks for the CORESET #0 of the physical downlink control channel by aligning with valid resource blocks of the physical broadcast channel in order to determine a size of the CORESET #0 of the physical downlink control channel; and
determining a control channel element allocation for the CORESET #0 of the physical downlink control channel based on: i) the lowest resource block, and ii) the valid resource blocks, of the CORESET #0.

16. The method according to claim 14, further comprising:
using the determined CORESET #0 of the physical downlink control channel to communicate with the network node.

17. The method according to claim 15, wherein the determining valid resource blocks for the CORESET #0 comprises:
determining that the valid resource blocks for the CORESET #0 of the physical downlink control channel are resource blocks with full control channel elements.

18. The method according to claim 16 or claim 17, wherein the determining valid resource blocks for the CORESET #0 comprises:
determining that the valid resource blocks for the CORESET #0 of the physical downlink control channel are resource blocks that cover fifteen resource blocks, with full control channel elements and partial control channel elements.

19. The method according to claim 15, wherein the determining the size of the CORESET #0 of the physical downlink control channel comprises one of:
determining a maximum number of full control channel elements that fit into fifteen resource blocks;
determining a maximum number of the full control channel elements and partial control channel elements that fit into the fifteen resource blocks;
determining a number of the full control channel elements using a predetermined number of control channel elements;
determining a number of resource blocks using predefined multiple of six resource blocks, that is above a total of the fifteen resource blocks.

20. The method according to claim 15, wherein the determining the control channel element allocation for the CORESET #0 of the physical downlink control channel comprises:
determining the control channel element allocation for the CORESET #0 of the physical downlink control channel using non-interleaved control channel element mapping.

21. The method according to claim 15, further comprising:
in response to determining the valid resource blocks for the CORESET #0, determining, using the physical broadcast channel, an index that provides information about the control channel element allocation within the valid resource blocks of the CORESET #0 of the physical downlink control channel.

22. The method according to claim 15, further comprising:
receiving, from the network node, a configuration associated with a physical downlink control channel; and
in response to the receiving, determining the CORESET #0 for all search spaces of the physical downlink control channel using the CORESET #0 in an initial bandwidth part.

23. The method according to claim 15, further comprising:
receiving, from the network node, a configuration associated with a physical downlink control channel; and
using one or more parameters comprised within the configuration associated with the physical downlink control channel to determine whether one of: a lower edge in frequency, or a higher edge in frequency, of the CORESET #0 of the physical downlink control channel is to be aligned with resource blocks of the physical broadcast channel.

24. The method according to claim 14, further comprising:
determining a channel bandwidth that the network node is operating with using the detected primary and secondary synchronisation signals.

25. The method according to claim 24, wherein the determining comprises determining a synchronisation raster point using the detected primary and secondary synchronisation signals so to determine the channel bandwidth that the network node is operating with.

26. The method according to claim 14, wherein one of: the method is performed by a user equipment.

27. (canceled)

28. A non-transitory computer readable medium comprising instructions, which when executed by an apparatus, cause the apparatus to perform at least the following:
detecting a primary synchronisation signal and a secondary synchronisation signal transmitted from a network node;
using the detected primary and secondary synchronisation signals to determine a number of resource blocks allocated for a punctured physical broadcast channel;
determining a lowest resource block, in frequency, of the punctured physical broadcast channel; and
determining a lowest resource block, in frequency, for a control resource set 0, CORESET #0, to be the same as the determined lowest resource block, in frequency, of the punctured physical broadcast channel.

29. The apparatus of claim 1, wherein the punctured physical broadcast channel is provided across only a partial number of subcarriers of a physical broadcast channel block.
